(19) United States
(12) Patent Application Publication
(10) Pub. No.: US 2008/0251666 A1
(43) Pub. Date: Oct. 16, 2008

(54) Balloon Holder Window Clip

(75) Inventor: Thomas E. Long, Houston, TX (US)

Correspondence Address: DAVID ARTHUR WALKER (THE WALKER LAW FIRM);C/O SPECTRASEIS AG, GIESSEREISTRASSE 5, ZURICH, CH-8005, CH

(73) Assignee: Thomas E. Long

(21) Appl. No.: 11/870,826

(22) Filed: Oct. 11, 2007

Related U.S. Application Data
(60) Provisional application No. 60/829,137, filed on Oct. 11, 2006.

(51) Int. Cl. E06B 7/28; A47G 29/00

(52) U.S. Cl. 248/208; 248/346.03

(57) ABSTRACT

The invention provides an apparatus for attaching a balloon holder to a car window or other planar surface. An apparatus secures a rod structure to the edge of a flat plane and includes an adapter platform with a stationary fin where the platform is securable to an edge of a planar structure. The apparatus also includes a display arm attachable to the stationary fin, the display arm includes a variable diameter internal space for accommodating the rod structure. The apparatus also includes a stand grip threadably attachable to the display arm on a distal end from the stationary fin where the stand grip includes a stand grip internal-extension for compressionally securing the rod structure to the distal portion of the display arm.

### CROSS REFERENCE TO RELATED APPLICATIONS

This application is a Utility Application of prior pending United States Provisional Application for Patent Ser. No.: 60/829,137 which is incorporated herein by reference for all purposes.

### BACKGROUND OF THE INVENTION

1. Field of the Invention

The present invention relates to an apparatus for holding a balloon holder or other device that includes a wire or rod.

2. Description of the Related Art

Large numbers of inflatable toy balloons are sold or giving away as novelty items each year. Toy balloons are of various general types; those made of latex, and those made of a non-elastomeric polymer film, usually polyethylene terphthalate (“Mylar”), or others. Latex balloons are stretchable, typically have a short neck surrounding the inflation opening, and may be sold either collapsed or inflated. When sold in inflated form, they may be tied to a stick; “Mylar” balloons are non-stretchable, typically are metallized to give a silvery appearance, have a long neck typically about four inches (10 cm) long, and are usually distributed in inflated form secured to a stick by means of a balloon holder.

Balloon holders may be of various designs and many include a base or clip for mounting the structure that holds a balloon. The base or clip typically has a hole or slot for engaging a wire or rod to secure the balloon. The base or clip structure may include a stem that is generally a hollow cylinder or tube. One end of the balloon stick is inserted into the open end of the tube.

### SUMMARY OF THE INVENTION

The invention provides an apparatus and system for securing balloon holders even in inclement weather and at various optional angles. The invention provides for a mounting to allow balloon holders to be secured to the edge of flat surfaces like windows at easily adjustable angles to the plane of the window. In one embodiment an apparatus secures a rod structure to the edge of a flat plane and includes an adapter platform with a stationary fin where the platform is securable to an edge of a planar structure. The apparatus also includes a display arm attachable to the stationary fin, the display arm includes a variable diameter internal space for accommodating the rod structure. The apparatus also includes a stand grip threadably attachable to the display arm on a distal end from the stationary fin where the stand grip includes a stand grip internal-extension for compressionally securing the rod structure to the distal portion of the display arm.

Additionally the apparatus may include a nut and bolt combination for securing the display arm to the stationary fin. In another embodiment a display arm contacts surface adjacent to the stationary fin with a substantially ridged surface. In another embodiments stationary fin contacts the surface adjacent to the display arm as a substantially ridged surface. The stand grip may include a non-smooth outside surface to allow better gripping. The inside diameter of the display arm may reduce substantially to zero along the length of the internal space for accommodating the rod structure. The combination of the compressional fitting and the internal space reducing to zero allows for a very secure attachment of the rod or wire to the adapter platform, and therefore to the planar surface. The stationary fin may also include a recessed space to accommodate a bolt head or a nut.

### BRIEF DESCRIPTION OF THE DRAWINGS

For detailed understanding of the present invention, references should be made to the detailed description of various disclosed embodiments, taken in conjunction with the accompanying drawings, in which like elements have been given like numerals, wherein:

FIG. 1 illustrates a window mount balloon clip apparatus for securing a device including a rod or wire extension to a planar surface;

FIG. 2 illustrates an exploded view of a window mount balloon clip apparatus;

FIG. 3 illustrates several further views of a balloon clip apparatus;

FIG. 4 illustrates a base structure including an adapter platform and window seat for a window mount balloon clip apparatus;

FIG. 5 illustrates several views of a holder shaft or display arm for a balloon clip apparatus including a cutaway view; and

FIG. 6 illustrates a stand grip for a balloon clip apparatus to secure a wire or rod in a display arm at a distal position from an adapter platform stationary fin.

### DETAILED DESCRIPTION

Embodiments disclosed or equivalent to those described herein provide an apparatus for mounting a device, like a balloon holder, including a rod or wire to a window or other similar substantially flat structure that includes an edge. An example balloon holder is described in U.S. patent application Ser. No. 11/400,851 filed on 10 Apr. 2005 which is included herein in its entirety for all purposes.

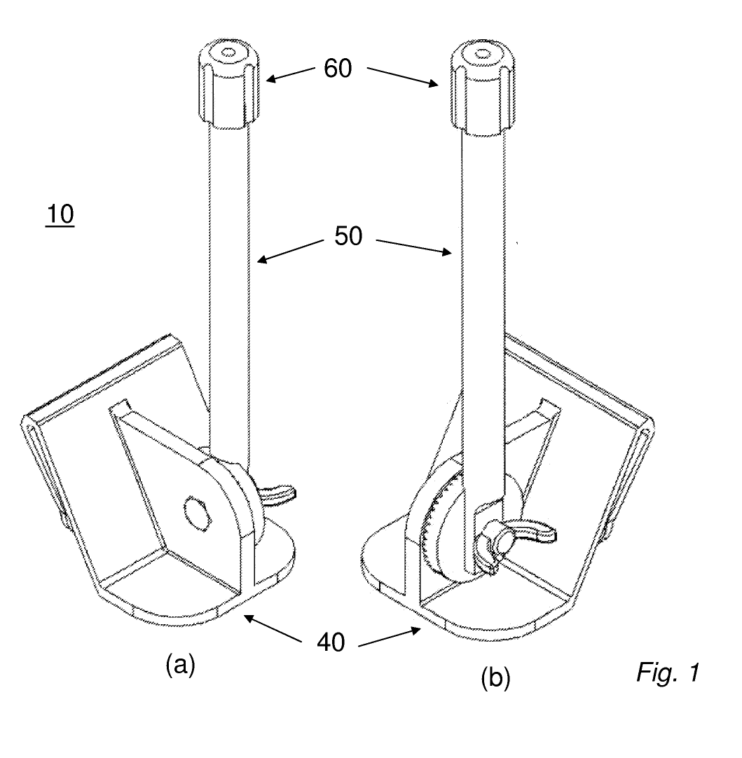

FIG. 1(a) and FIG. 1(b) illustrate alternative views of an embodiment that may be used to secure a balloon holder or other device that includes a wire or rod to a window, for example a car window. An advantage of the apparatus is the holder may optionally be directed substantially in the up direction (normal to the earth), or a plurality of holders may be positioned so that all the holders are in substantial conformity of position as a group regardless of whether the windows as a group are at the same or similar angles.

The apparatus includes an adapter platform 40, a display arm 50 and a Stand Grip 60. An adapter platform 40 includes a means for attaching the platform to a window edge or other flat surface. A display arm 50 may be attached to platform 40. Display arm 50 may include Stand Grip 60 at a distal end from platform 40.

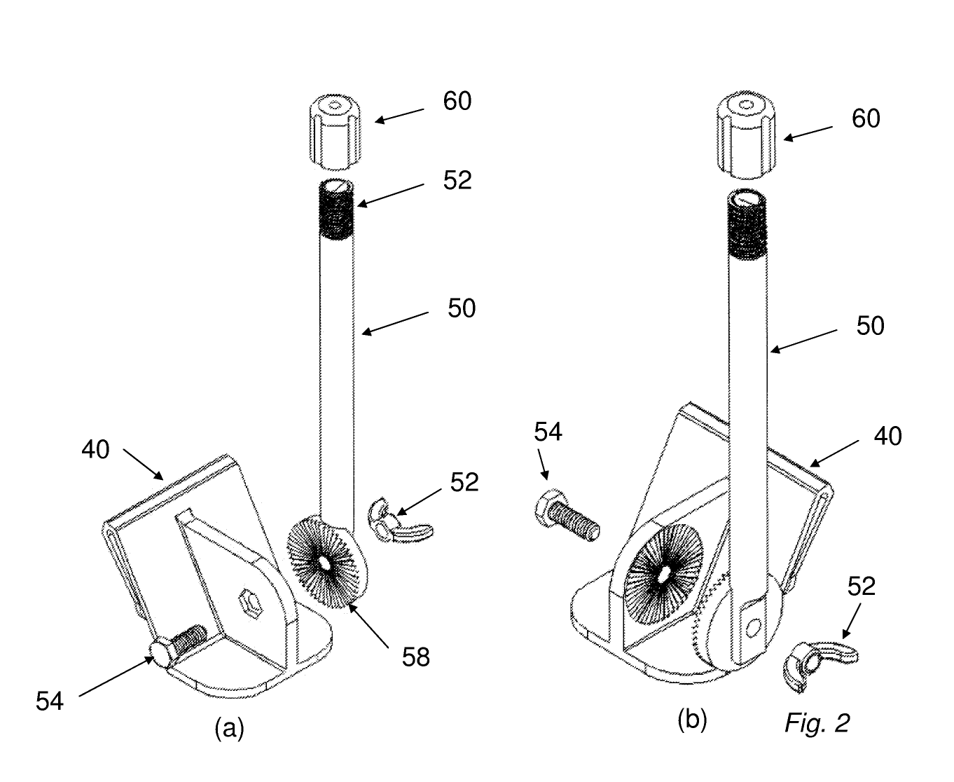

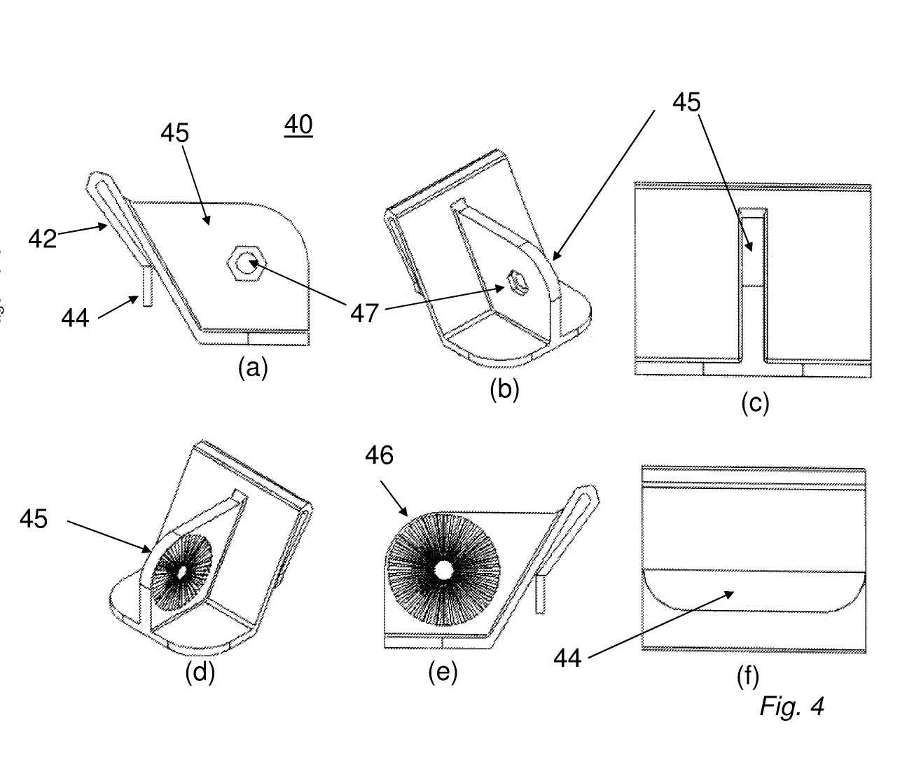

FIG. 2(a) and FIG. 2(b) illustrate alternative exploded views of embodiments that may be used to secure a balloon holder or other wire device to a window. An adapter platform 40 (see FIG. 4) includes a means for attaching the platform to a window edge or other flat surface. A bolt 54 may be attached through an opening in a stationary fin (see 45 of FIG. 4) and secured with a nut 52 for bolt 54, for example a wing nut or any other nut with a shape amenable to tightening by hand. In this manner display arm 50 may be adjustably positioned at nearly any desired angle and a group of display arms may be arrayed in conformity with the group. Display arm 50 may be attached at various optional angles to platform 40. Display arm 50 may include threadably adjustable Stand Grip 60 at a distal end from platform 40.

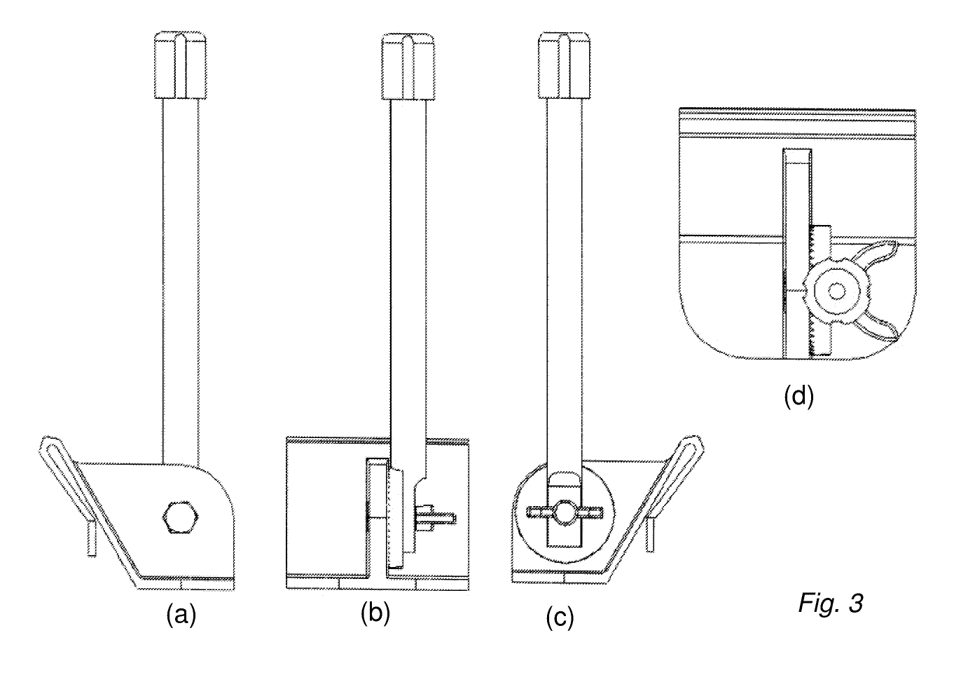

FIG. 3(a), FIG. 3(b), FIG. 3(c) and FIG. 3(d) illustrate different views of an assembled wire or rod holding window clip. It will be appreciated that the embodiment illustrated may be equal to an embodiment constructed in a mirror image so that a right facing or left facing display arm attachment is equivalent, or the bolt and nut combination may be reversed. FIG. 3(a) is a view of an embodiment as may be seen from the left. FIG. 3(b) is a view of an embodiment as may be seen looking directly with the window to the rear. FIG. 3(c) is a view from the right side. FIG. 3(d) is a view looking down towards the adapter platform and parallel to the display arm.

Various illustrative views of adapter platform 40 are illustrated with FIG. 4. FIG. 4(a) illustrates window seat 42 along with window seat extension 44. Stationary fin 45 may include ribs, ridges or notches 46 (e.g. FIG. 4(e)) for aiding in securing display arm 50 in a locked position relative to the adapter platform 40. It will be understood that ribs, ridges or notches may be of several different forms. Additionally, a rough surface (similar to a sandpaper texture) on one or both contacting surfaces may be used to aid stationarity as well. Alternatively, compression may be used to secure display arm 50. Stationary fin 45 may include an indentation around a bolt hole to accommodate a bolt head 47 as illustrated in FIG. 4(b). FIG. 4(c) is a view of an adapter platform as may be seen looking directly towards a window. FIG. 4(d) is an alternate perspective view. FIG. 4(f) is a view of an adapter platform as seen from behind. It will be appreciated by those skilled in the art that a stationary fin may be positioned at any position relative to the window seat, not just substantially centered as illustrated.

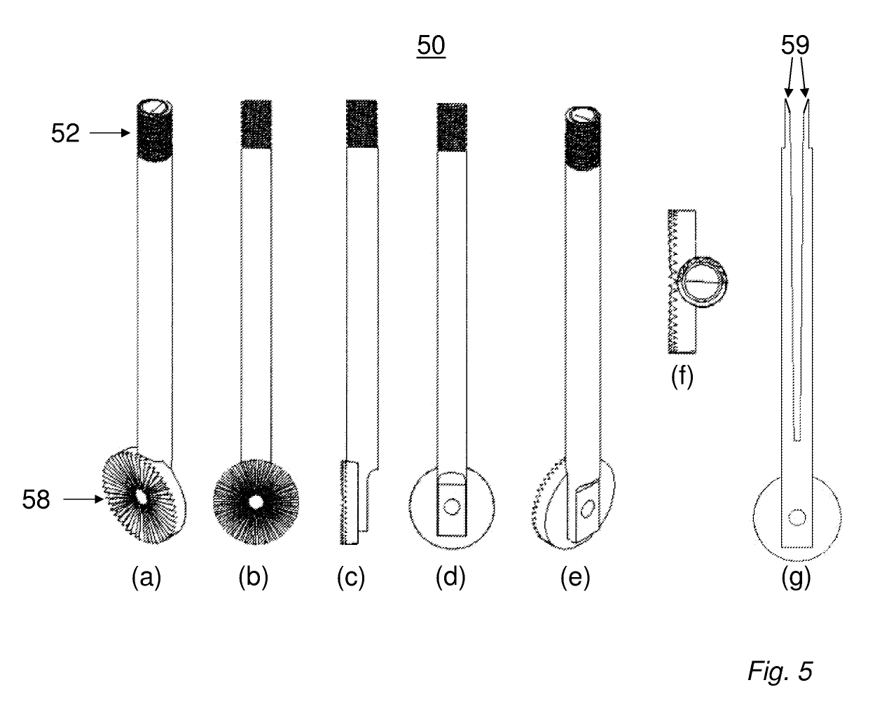

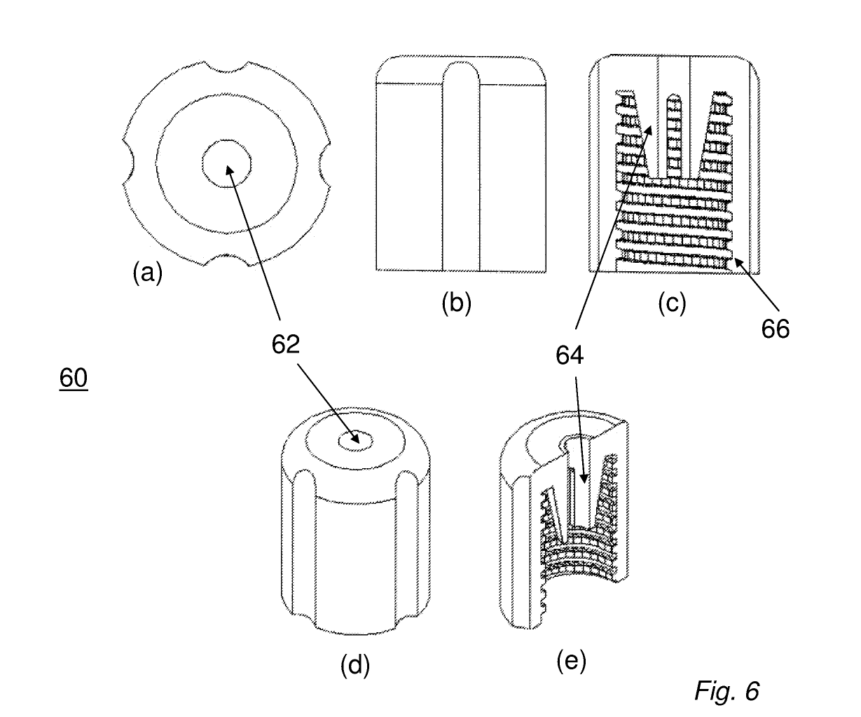

FIG. 5 illustrates various views of a display arm. FIG. 5(a) is a perspective view similar to the view of FIG. 2(a) that includes a threaded end 52 distal from the portion of the arm 50 that attaches to the adapter platform 40. The portion of arm 50 that attaches to platform 40 may include ridged or notched material 58 to allow secure arm 50 positioning relative to platform 40. FIG. 5(b), FIG. 5(c) and FIG. 5(d) illustrate alternative views of arm 50. FIG. 5(e) is a perspective view similar to the view of FIG. 2(b). FIG. 5(f) illustrate arm 50 as viewed from above. FIG. 5(g) illustrates a view of arm 50 as cut through substantially near the middle. As illustrated in this cutaway view by the display art top 59 (the end distal from end secured to platform 40) the arm is shaped to fit with Stand Grip 20 (see FIG. 6) so that when Stand Grip 20 is conformably engaged with threads 66, Stand Grip internal-extension 64 will tighten onto a wire inserted into display arm 50.

FIG. 6(a) illustrates a Stand Grip 20 as viewed from above with opening 62 to allow insertion of a wire or rod. FIG. 6(b) illustrates a side view. FIG. 6(c) illustrates a cutaway view through the Stand Grip 20 including Stand Grip internal-extension 64 and threads 66. FIG. 6(d) is a perspective view of Stand Grip 20. FIG. 6(e) is a perspective cutaway view of Stand Grip 20.

In one embodiment an apparatus secures a rod structure to the edge of a flat plane and includes an adapter platform with a stationary fin where the platform is securable to an edge of a planar structure. The planar structure may be a car window. The apparatus also includes a display arm attachable to the stationary fin, the display arm includes a variable diameter internal space for accommodating the rod structure. The apparatus also includes a stand grip threadably attachable to the display arm on a distal end from the stationary fin where the stand grip includes a stand grip internal-extension for compressionally securing the rod structure to the distal portion of the display arm.

Additionally the apparatus may include a nut and bolt combination for securing the display arm to the stationary fin. In another embodiment a display arm contacts a surface adjacent to the stationary fin with a substantially ridged surface. In another embodiment stationary fin contacts the surface adjacent to the display arm as a substantially ridged surface. The stand grip may include a non-smooth outside surface to allow better gripping. The inside diameter of the display arm may reduce substantially to zero along the length of the internal space for accommodating the rod structure. The combination of the compressional fitting and the internal space reducing to zero allows for a very secure attachment of the rod or wire to the adapter platform, and therefore to the planar surface. The stationary fin may also include a recessed space to accommodate a bolt head or a nut.

To adjust the angle of the display arm relative to a window or other planar surface after the adapter platform is secured to an edge, the nut (e.g. a wing nut) is loosened sufficiently. The shaft direction of the display arm is adjusted to a desired position and the nut is then tightened.

To secure a wire or rod within the display arm the stand grip (or cap) is loosened for example by turning the thread counterclockwise (for regular threads). The wire or rod (or balloon stand) is inserted through the hole 62 in the cap (stand grip) until the rod is unable to travel deeper (for example where the internal display arm diameter reduces to substantially zero or the rod is unable to penetrated further). The cap/stand grip is then tightened to thereby secure the wire, rod or balloon holder in the window mounting apparatus.

While various embodiments have been shown and described, various modifications and substitutions may be made thereto without departing from the spirit and scope of the invention. Accordingly, it is to be understood that the present invention has been described by way of illustrations and not limitation.

What is claimed is:

1. An apparatus for securing a rod structure to the edge of a flat plane comprising:
(a) an adapter platform with a stationary fin, the platform securable to an edge of a planar structure;
(b) a display arm attachable to the stationary fin, the display arm comprising a variable diameter internal space for accommodating the rod structure, and
(c) a stand grip threadably attachable to the display arm on a distal end from the stationary fin, the stand grip comprising a stand grip internal-extension for compressionally securing the rod structure to the distal portion of the display arm.

2. The apparatus of claim 1 further comprising a nut and bolt combination for securing the display arm to the stationary fin.

3. The apparatus of claim 1 further comprising a display arm wherein a contact surface adjacent to the stationary fin is a substantially ridged surface.

4. The apparatus of claim 1 further comprising a stationary fin wherein a contact surface adjacent to the display arm is a substantially ridged surface.

5. The apparatus of claim 1 wherein the stand grip further comprises a non-smooth outside surface.

6. The apparatus of claim wherein the inside diameter of the display arm reduces substantially to zero along the length of the internal space for accommodating the rod structure.

7. The apparatus of claim 1 wherein the stationary fin further comprises a recessed space to accommodate at least on of: i) a bolt head and ii) at nut.

8. An apparatus for securing a balloon holder to an edge of a window comprising:
(a) an adapter platform with a stationary fin, the platform securable to an edge of a window;
(b) a display arm attachable to the stationary fin, the display arm comprising a variable diameter internal space for accommodating the balloon holder, and
(c) a stand grip threadably attachable to the display arm on a distal end from the stationary fin, the stand grip comprising a stand grip internal-extension for compressionally securing the balloon holder to the distal portion of the display arm.

9. The apparatus of claim 1 further comprising a nut and bolt combination for securing the display arm to the stationary fin.

10. The apparatus of claim 1 further wherein a contact surface of the stationary fin is at least one selected from the group consisting of: i) a substantially ridged surface for securing the display arm and ii) a substantially rough surface for securing the display arm.

11. The apparatus of claim 1 further wherein a contact surface of the display arm is at least one selected from the group consisting of: i) a substantially ridged surface for securing the display arm to the stationary fin and ii) a substantially rough surface for securing the display arm to the stationary fin.

12. The apparatus of claim 1 wherein the stand grip further comprises a non-smooth outside surface.

13. The apparatus of claim wherein the inside diameter of the display arm reduces substantially to zero along the length of the internal space for accommodating the rod structure.

14. The apparatus of claim 1 wherein the stationary fin further comprises a recessed space to accommodate at least on of: i) a bolt head and ii) at nut.

15. An apparatus for securing a balloon holder to an edge of a window comprising:
(a) an adapter platform with a stationary fin, the platform securable to an edge of a window;
(b) a display arm attachable to the stationary fin, the display arm comprising a variable diameter internal space for accommodating the balloon holder,
(c) a stand grip threadably attachable to the display arm on a distal end from the stationary fin, the stand grip comprising a stand grip internal-extension for compressionally securing the balloon holder to the distal portion of the display arm; and
(d) a nut and bolt combination for securing the display arm to the stationary fin.

16. The apparatus of claim 1 further wherein a contact surface of the stationary fin is at least one selected from the group consisting of: i) a substantially ridged surface for securing the display arm and ii) a substantially rough surface for securing the display arm.

17. The apparatus of claim 1 further wherein a contact surface of the display arm is at least one selected from the group consisting of: i) a substantially ridged surface for securing the display arm to the stationary fin and ii) a substantially rough surface for securing the display arm to the stationary fin.

18. The apparatus of claim 1 wherein the stand grip further comprises a non-smooth outside surface.

19. The apparatus of claim wherein the inside diameter of the display arm reduces substantially to zero along the length of the internal space for accommodating the rod structure.

20. The apparatus of claim 1 wherein the stationary fin further comprises a recessed space to accommodate at least on of: i) a bolt head and ii) at nut.
